(19) United States
(12) Patent Application Publication
(10) Pub. No.: US 2022/0151739 A1
(43) Pub. Date: May 19, 2022

(54) MOLDING DEVICE FOR A DENTAL IMPLANT

(71) Applicant: Tim UEBERMUTH, Celle (DE)

(72) Inventor: Tim UEBERMUTH, Celle (DE)

(21) Appl. No.: 17/437,554

(22) PCT Filed: Mar. 11, 2020
(86) PCT No.: PCT/EP2020/056501

§ 371 Date: Jan. 3, 2022

(30) Foreign Application Priority Data
Mar. 12, 2019 (DE) 10 2019 203 348.2

(51) Int. Cl. A61C 8/00

(52) U.S. Cl. CPC A61C 8/0001; A61C 8/0068; A61C 8/0066

(57) ABSTRACT

An impression device for a dental implant includes an impression cap having a first connection opening extending along a longitudinal axis and a first connecting section, and a connector element for fixing the cap relative to the implant. An impression abutment has an abutment body having, on a first side, an end face to be attached to the implant and, on a second side lying along the longitudinal axis from the first side, a second connecting section for connecting to the first connecting section. The impression abutment further has a second connecting opening extending along the longitudinal axis and, in a fitted position, in which the impression abutment and the cap are attached to one another, aligned along the longitudinal axis with the first connection opening that the connector element can be guided through the first connection opening and the second connection opening for connecting to the dental implant.

The invention relates to an impression device for a dental implant according to the preamble of claim 1.

Such an impression device comprises an impression cap which has a first connecting opening extending along a longitudinal axis and a first connecting section, and a connector element for fixing the impression cap relative to the dental implant.

For example, to provide a dental prosthesis for a toothless jaw, dental prosthesis structures in the form of prostheses are used which are connected to the jawbone via osseointegrated implants inserted into a jaw bone. Such rigid anchors of the prosthesis with the jawbone have proven to be advantageous with respect to merely periodontal bearing of dental prosthesis structures.

In order to fasten a prosthesis to a jaw bone of a patient, implants are conventionally initially inserted into the jaw bone in the context of a surgical intervention. After healing of the implants, seams of the seat of the implants in the jaw bone are checked. Subsequently, an impression of the implant positions is carried out, and connecting parts required for fastening the final prosthesis are arranged as male parts on the implants. The male parts can be manufactured as so-called telescopic crowns, but can also be integrated into a bar (primarily blocking) connecting the implants to one another. Finally, the final dental prosthesis is individually manufactured as a prosthesis in the sense of a female part, adapted to the male part and tried on the patient.

However, an impression device of the type described here relates not only to a dental prosthesis in the case of toothless patients, but generally every implant-supplied situation in the implant-prosthetic supply. In this context, shaping can be used not only for producing a prosthesis, but also for individual tooth situations (crowns) and supplies starting from two implants (bridges).

Within the scope of the impression of the implant positions, impression devices, also referred to as shaping posts, are used, by means of which a negative shape can be obtained on the basis of the implanted dental implants, in which the position of each dental implant is impressed. During molding, an impression compound is applied to impression caps of impression devices attached to existing dental implants, and after curing of the impression compound, the negative mold thus obtained is removed from the dental implants with the impression caps remaining in the negative mold. On the basis of the negative shape, for example, a prosthesis can then be manufactured individually for a patient in such a way that the prosthesis can be attached to the already implanted dental implants as intended.

Different solutions for such impression devices are known.

An impression cap for a dental implant known from EP 2 368 518 B1 has at an end region a connector element which is designed to provide a releasable snap connection between the impression cap and a dental implant.

An impression post for a dental implant, known from EP 2 213 259 A1, has an impression cap which is composed of an inner sleeve and an outer shell which is surrounded radially on the outside by the inner sleeve. In this case, the outer sleeve is detachably connected to the inner sleeve.

EP 0 727 193 A1 describes an impression device in which an impression cap is to be connected to a dental implant via an inner sleeve.

In the context of a surgical procedure, dental implants are integrated into bone structures of a patient in such a way that they find a firm hold in the bone. Axes of the dental implants can in this case deviate from one another, which makes it more difficult to attach, for example, to a prosthesis, but in addition can also impair the shaping via impression devices. Thus, in the case of molding, it is in particular ensured that, owing to the separation of the impression caps (remaining in the cured impression compound) from the dental implants, there is no excessive stress in the impression compound or on the dental implants in order to avoid damage to the dental implants, to the gums or to the negative mold obtained.

The object of the present invention is to provide an impression device which, in a simple manner, makes it possible to form implanted dental implants with a favorable separation of the impression cap from an associated dental implant and is easy to produce.

This object is achieved by an embodiment having the features of claim 1.

Accordingly, the impression device has an impression abutment with an abutment body which, on a first side, has a front face to be attached to the dental implant and a second connecting section for connecting to the first connecting section of the impression cap on a second side lying along the longitudinal axis from the first side. The impression abutment has a second connecting opening which extends along the longitudinal axis and, in a fitted position, in which the impression abutment and the impression cap are attached to one another, is aligned along the longitudinal axis with the first connecting opening of the impression cap such that the connector element can be guided through the first connection opening and the second connection opening for connection to the dental implant.

The impression device is thus three-divided. Thus, the impression device has an impression cap, an impression abutment and a connector element for jointly fixing the impression cap and the impression abutment on an associated dental implant. The impression cap and the impression abutment are connected to one another and are to be fastened together on an associated dental implant, in that the connector element is guided through the connecting openings of the impression cap and the impression abutment and is connected to the dental implant in order in this way to fix the impression cap and the impression abutment on the dental implant.

The impression device serves to form an already implanted dental implant. If a plurality of dental implants are implanted into the bone structure of the jaw bone of a patient, an impression device is used on each dental implant, which is attached to the respective dental implant for shaping and is fastened to the associated dental implant via the connector element. For molding, an impression compound is then attached to the impression devices such that the impression caps of the impression devices are surrounded by the impression compound and, after curing of the impression compound, the negative mold thus obtained can be removed from the dental implants together with the impression caps. The position and orientation of the dental implants is defined in the negative form via the impression caps, so that, for example, a suitable prosthesis, crown or bridge with correctly positioned and aligned fastening devices can be produced on the basis of the impression caps.

In order to remove the cured impression compound, the impression caps are separated from the impression abutments by releasing the connector elements in such a way that the impression caps can be removed from the impression abutments remaining on the dental implants. During removal, the connecting sections of the impression abutments on the one hand and the impression caps on the other hand are removed from one another, so that the impression caps remain in the impression material and the impression abutments remain on the dental implants.

The connecting portions of each impression abutment and an associated impression cap are preferably shaped in such a way that the impression cap can be removed from the impression abutment at an angle to the longitudinal axis not equal to 0°. This makes it possible to separate each impression cap from the associated impression abutment without tension, even if the implant axes of a plurality of dental implants implanted in the jawbone of a patient are not aligned parallel to one another. As a result of the impression caps of the impression devices being able to be separated from the associated impression abutments remaining on the dental implants in a stress-free manner, it is in particular applied after curing sides of the negative mold, that is to say on the sides of the cured impression compound, prevent damage during removal from the dental implants.

Due to the fact that the impression abutments remain on the dental implants and are separated from the dental implants only after removal of the negative form, the risk of damage to the sides of the dental implants is also reduced.

In addition, for example, the gums of a patient can also be protected when the impression abutments are placed in the gingiva (gingival), but the impression caps do not engage or engage only insignificantly into the gums. The removal of the negative form from the dental implants can thus take place without impairing the gums.

In one embodiment, the second connecting section of the impression abutment extends at an angle not equal to 0° to the longitudinal axis. The second connecting section is thus not oriented parallel to the longitudinal axis, but at an angle. For example, the second connecting section can be arranged in an angle between 30° and 90° with respect to the longitudinal axis. Alternatively, the second connecting section is arranged at an angle of 90° to the longitudinal axis and thus extends substantially along a plane extending perpendicularly to the longitudinal axis on the end face on the abutment body of the impression abutment.

The second connecting portion can have a basic shape which is rotationally symmetrical (relative to the longitudinal axis). For example, the second connecting section can have a conical shape by being shaped, for example, as a truncated cone, with a cone angle, for example between 30° and 60°, for example 45°.

If the second connecting section is shaped as a truncated cone, the second connecting section forms an engagement stump in the manner of a male mould for engaging in the associated first connecting section of the impression cap. In this case, the first connecting section can be designed, for example, in the manner of a die as an engagement recess for the engagement stocking of the second connecting section.

In one embodiment, the first connecting portion of the impression cap is formed complementary to the second connecting portion of the abutment body of the impression abutment. Is the second connecting section thus shaped conically as a truncated cone, the first connecting portion of the impression cap then has a complementary shape in the manner of a conical engagement opening as engagement for the second connecting portion.

Due to the fact that the second connecting section of the impression abutment—and in a complementary manner the first connecting section of the impression cap—extends at an angle to the longitudinal axis of the impression device, for example by conical shaping of the second connecting section and of the associated first connecting section, it is made possible to remove the impression cap from the impression abutment at an angle not equal to 0°. Thus, the impression caps of impression devices on dental implants whose implant axes deviate from one another and in particular do not extend parallel to one another can be removed together in a stress-free manner from the associated impression abutments so that the risk of stress on the negative mold obtained by the cured impression compound—which otherwise could lead to an impairment of the accuracy of the positioning of the impression caps for displaying the locations and orientations of the dental implants—is avoided.

In one embodiment, the second connecting section has at least one form-fit element for connecting the impression abutment to the impression cap in the attached position in a rotationally fixed manner. In the attached position, the connecting portions of the impression abutment and the impression cap rest against each other. By means of one or more form-fit elements, the impression abutment and the impression cap are fixed relative to one another in the attached position, with respect to the longitudinal axis of the impression device, so that the rotational position of the impression abutment and of the impression cap is secured to one another.

For example, a plurality of form-fit elements can be formed on the connecting section of the impression abutment, which form-fit elements are circumferentially equally spaced apart about the longitudinal axis and are thus arranged regularly with respect to one another.

Such form-fit elements can be formed, for example, by webs extending radially to the longitudinal axis. Complementary form-fit elements are provided on the first connecting section of the impression cap, for example in the form of grooves.

In another embodiment, a toothing extending circumferentially about the longitudinal axis can be formed on each of the connecting sections with tooth tips and tooth valleys extending radially to the longitudinal axis, wherein the toothings engage with one another in a form-fitting manner in the attached position of the impression abutment and the impression cap, so that the impression abutment and the impression cap are fixed in a rotationally fixed manner about the longitudinal axis to one another.

In the attached position, the impression abutment and the impression cap are braced relative to one another via the connector element and are thus fixed to one another. Here, the connector element is connected to the dental implant. By releasing the connector element from the dental implants, the impression abutment and the impression cap can be released from one another such that the impression cap can be removed from the impression abutment.

The second connecting section of the impression abutment is formed on the second side of the abutment body facing away from the dental implant and is thus attached at the end face to the side remote from the dental implant. By contrast, the impression abutment can be attached to the associated dental implant via the first side and connected to the dental implant in order to fix the impression device to the dental implant.

In one embodiment, the impression abutment has a shaft which protrudes from the abutment on the first side along the longitudinal axis and can be inserted into a plug-in opening of the dental implant. A plug-in connection between the impression abutment and the associated dental implant can thus be produced via the shaft, wherein the shaft can, for example, be held in the associated plug-in opening of the dental implant in a rotationally secure manner in order to attach the impression abutment to the dental implant in a rotationally secure manner.

For example, one or more anti-rotation elements, for example in the form of bars extending parallel to the longitudinal axis, can be formed on the shaft, which elements engage in associated complementary anti-rotation elements on a wall surrounding the insertion opening of the dental implant and thus create a rotationally secure connection between the impression abutment and the dental implant. If the impression cap has been removed from the impression abutment, the impression abutment can be removed from the dental implant in a simple manner by removing the shaft protruding from the impression body from the insertion opening of the dental implant.

The connector element can be designed, for example, as a screw element with a screw to be screwed to the dental implant. For molding, the impression device with the impression abutment and the impression cap is attached to a dental implant and attached to the dental implant via the connector element by passing the connector element through the connecting openings of the impression abutment and the impression cap and being screwed with its screw end into an associated screw opening of the dental implant. In this way, the impression abutment and the impression cap are clamped to one another and fixed to the dental implant. After applying an impression compound to the impression cap, the connector element can be released from the dental implant by unscrewing, so that the negative mold obtained from the cured impression compound can be removed from the dental implant together with the impression cap, wherein the impression abutment initially remains on the dental implant and can be removed from the respective dental implant after removal of the negative mold.

The impression abutment and the impression cap can, for example, each be formed from a metal material, in particular a titanium material. This enables, for example, multiple use of the impression device with the impression abutment and the impression cap.

Alternatively, however, it is also conceivable to manufacture the impression abutment and/or the impression cap from another material, for example a plastic material, wherein in this case the impression device can be designed, for example, for an one-way use.

The invention will be explained in more detail below with reference to the exemplary embodiments illustrated in the figures. Shown is:

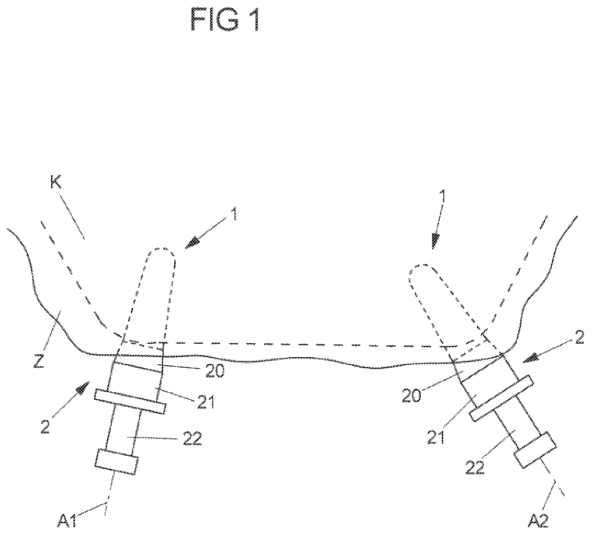

FIG. 1 shows a schematic view of impression devices on dental implants on a bone structure of a patient;

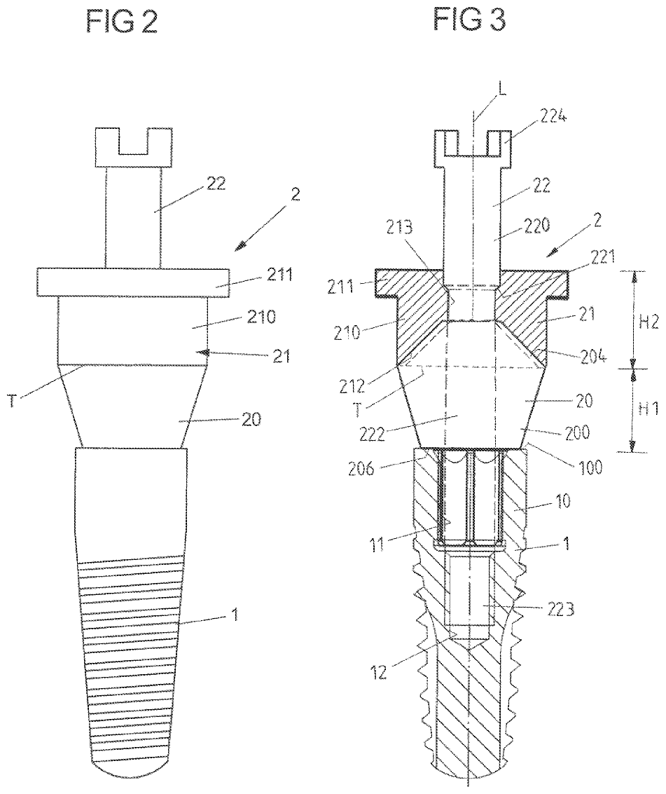

FIG. 2 shows a view of an impression device on a dental implant;

FIG. 3 shows a partially sectioned view of the arrangement according to FIG. 2;

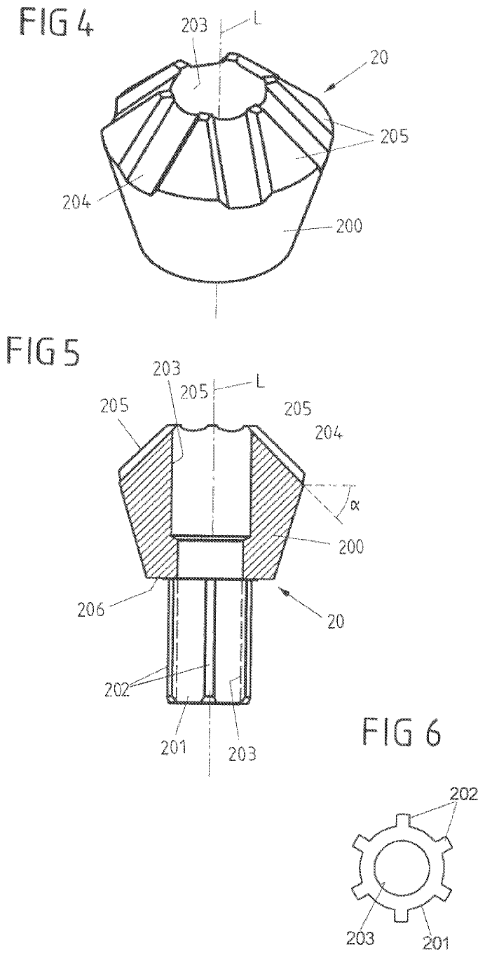

FIG. 4 shows a separate view of an impression abutment of the impression device;

FIG. 5 shows a partially sectioned view of the impression abutment;

FIG. 6 shows a sectional view through a shaft of the impression abutment;

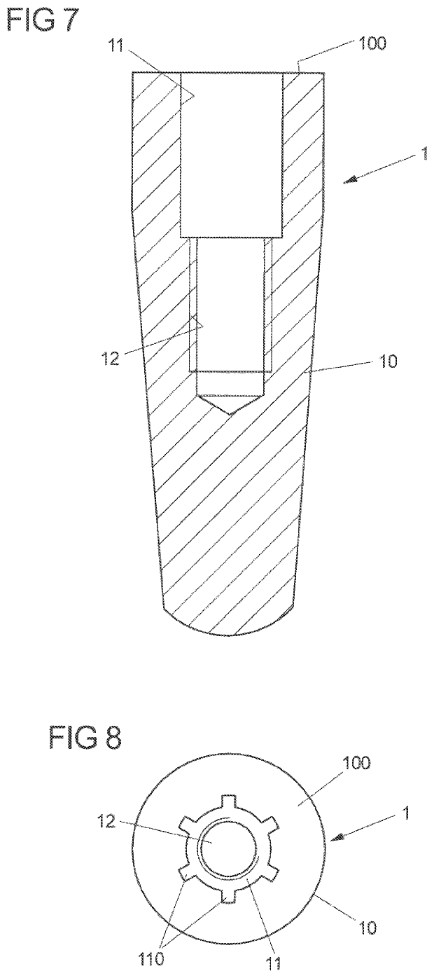

FIG. 7 shows a schematic view of a dental implant;

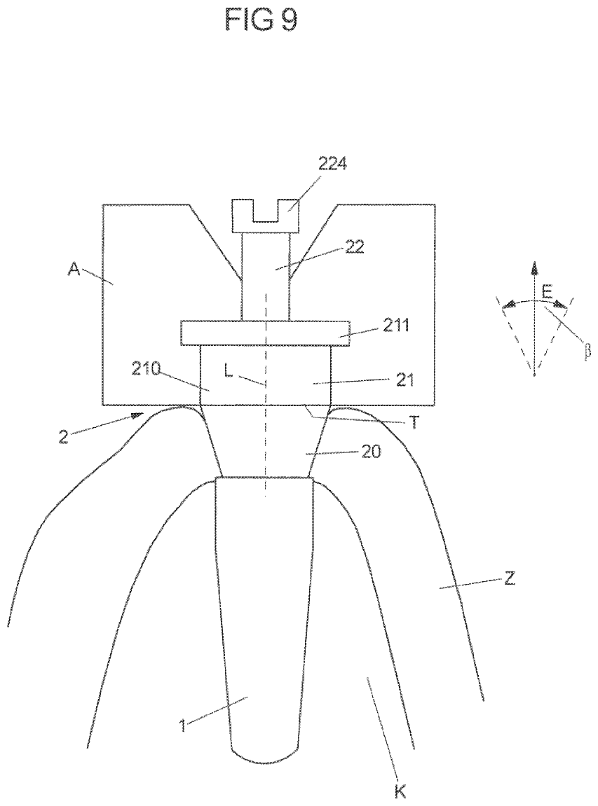

FIG. 8 shows a plan view of the dental implant; and

FIG. 9 shows a schematic view of an impression device after attachment of one impression compound.

FIG. 1 shows, in a schematic view, a bone structure K of a jaw bone of a patient in which dental implants 1 are implanted for releasable fastening, for example, of a prosthesis, a crown or bridge.

In general, for providing, for example, a prosthesis, dental implants 1 are first implanted into the jaw bone of a patient, in order then, after implantation, to shape the dental implants 1 and to produce the prosthesis on the basis of a negative mold thus obtained. The prosthesis is produced in particular on the basis of the actual positioning and alignment of the dental implants 1, so that the prosthesis can be attached to the implanted dental implants 1 as intended and can be fixed to the dental implants 1.

For molding, impression devices 2 are used, which—in the exemplary embodiment shown—consists of an impression abutment 20 attached to the respective dental implant 1, an impression cap 21 and a connector element 22 in the form of a screw connecting the impression cap 21 and the impression abutment 20 to the dental implant 1. Here, an impression device 2 is arranged on each dental implant 1, so that an impression compound A for obtaining a negative mold can be attached to the impression devices 2, in particular the impression caps 21 of the impression devices 2, and the position and orientation of each dental implant 1 in the negative form can thus be displayed via the impression devices 2.

As can be seen from FIG. 1, dental implants 1 with implant axes A1, A2 that differ considerably from one another can be implanted into the bone structure K of a jaw bone. Against this background, it is desirable, despite existing deviations in the implant axes of dental implants, to allow the impression cap 21 to be separated as far as possible from the respective dental implant 1 in order to permit a simple, exact shaping.

This is achieved in the molding device 2 proposed here in that the impression cap 21 is functionally separated from the impression abutment 20 and the impression device 2—together with the impression abutment 20, the impression cap 21 and the connector element 22—is thus formed in three parts. The impression cap 21 is not attached directly to the dental implant 1, but with the intermediate position of the impression abutment 20 in such a way that the impression abutment 20 is connected to the dental implant 1 and the impression cap 21 bears against the impression abutment 20.

During molding, the impression compound A is placed in particular around the impression caps 21 of the impression devices 2, so that the impression caps 21 are accommodated in the impression compound A, as can be seen from FIG. 9. The impression caps 21 each have a body 210 with a collar section 211 projecting radially on a side facing away from the impression abutment 20, via which collar section a fixed, form-fitting connection is created between each impression cap 21 and the impression compound A.

When the impression compound A is applied, the connector element 22 (optionally with removal of a so-called spoon) of each impression device 2 remains accessible from the outside in such a way that, after curing of the impression compound A, the connector elements 22 of the impression devices 1 can be released and the cured impression compound A can thus be removed together with the impression caps 21 along a removal direction E from the impression abutments 20 and thus from the dental implants 1.

As can be seen from a combination of FIGS. 2 to 5, the impression abutment 20 of each impression device 2, on a side of an abutment body 200 facing away from the dental implant 1, has a conical connecting portion 204 in the form of a truncated cone, on which, when the impression cap 21 is attached, an associated complementary connecting portion 212 in the form of a conical engagement recess of the impression cap 21 comes to lie.

The cone angle a of the connecting section 204 (and correspondingly the complementary cone angle of the connecting section 212 of the impression cap 21) can lie, for example, in a range between 30° and 60°, for example at 45°.

However, it is also conceivable and possible to design the connecting portions along a plane extending perpendicularly to the longitudinal axis L and thus not to be conical, but rather substantially flat.

Form-fit elements 205 in the form of raised wedge sections, which are separated from one another by groove-shaped depressions extending radially to a longitudinal axis L, are formed on the connecting section 204 of the impression abutment 20. Complementary form-fit elements are formed on the connecting section 212 on the inside of the impression cap 21 so that, by engagement of the form-fitting elements 205 of the impression abutment 20 in the complementary form-fitting elements on the connecting portion 212 of the impression cap 21, the impression abutment 20 and the impression cap 21 are fixed in a fixed position relative to one another in a rotationally fixed manner.

A shaft 201 projects from the abutment body 200 along the longitudinal axis L and can be plugged into an associated plug opening 11 of the dental implant 1, as can be seen from a combination of FIGS. 5 to 8. The shaft 201 extends axially along the longitudinal axis L and projects from the abutment body 200 in such a way that the shaft 201 engages in the insertion opening 11 in a position connected to the dental implant 1 and a front face 206 comes to rest on an associated contact surface 100 on the end face of the dental implant 1 on a side of the abutment body 200 facing away from the connecting section 204, as can be seen in particular from FIGS. 2 and 3.

The shaft 201, on its outer lateral surface, has anti-rotation elements 202 in the form of webs which extend parallel to the longitudinal axis L and which, for the rotationally secured connection of the impression abutment 20 to the dental implant 1, engage in associated anti-rotation elements 110 in the form of groove-shaped depressions on a wall of the dental implant 1 surrounding the insertion opening 11, as is shown in FIG. 6 (which represents the shaft 201 in cross section) in combination with FIG. 8 (which represents a plan view of the dental implant 1).

For fastening the impression device 2 to an associated dental implant 1, the impression abutment 20 is attached to the dental implant 1 together with the impression cap 21. The connector element 22 is then connected to shaft sections 220, 222 by connecting openings 203 extending along the longitudinal axis L and aligned with one another, 213 of the impression cap 21 and of the impression abutment 20 and screwed into an associated screw opening 12 within the dental implant 1 via a screw 223 on the shaft portion 222. By means of a step 221 formed between the shaft sections 220, 222, the impression cap 21 and the impression abutment 20 are thereby fixed to one another and to the dental implant 1.

The impression abutment 20 is shaped in such a way that it can be accommodated substantially in the gums Z of a patient when placed on an associated dental implant 1, as can be seen, for example, from FIG. 9. Accordingly, the height H1 (see FIG. 3) of the impression abutment 20 can be dimensioned such that a parting line T between the impression abutment 20 and the impression cap 21 comes to lie approximately at the level of the outer side of the gum in the case of conventional conditions.

By contrast, the impression cap 21 is intended to be surrounded by the impression compound A and remain in the negative mold thus obtained after curing of the impression compound A. The height H2 of the impression cap 21 is adapted for a secure hold in the impression compound A and can, for example, also be significantly larger than shown in FIGS. 2 and 3.

In order to remove the cured impression compound A, a user can access the head 224 of the connector element 22 of each impression device 2 in order to release the screw connection and thereby allow the impression cap 21 to be separated from the respective impression abutment 20.

Due to the fact that the connecting sections 204, 212 are formed at an angle to the longitudinal axis L of the impression device 2, the impression cap 21 and the impression abutment 20 can be removed from one another without stress, even if the removal direction E—for example in the case of implant axes A1, A2 which are not oriented parallel to one another—differs from the longitudinal axis L of the impression device 2 within an angle cone g (see FIG. 9).

Since the impression abutment 20 remains on the dental implant 1 when the impression cap 21 is removed, damage in particular in the region of the gingiva Z and also on the dental implant 1 when the cured impression compound A is removed is avoided. After removal of the cured impression compound A, each impression abutment 20 can be removed from the respective dental implant 1 in a gentle manner, with the shaft 201 being pulled out of the insertion opening 11 of the associated dental implant 1.

The idea on which the invention is based is not restricted to the exemplary embodiments described above, but can also be implemented in completely different embodiments.

An impression device of the type described here can generally be used for a dental prosthesis in the case of toothless patients, but also for other implant-supplied situations in the orthodontic treatment. In this context, shaping can be used not only for producing a prosthesis, but also for individual tooth situations (crowns) and supplies from two implants (bridges).

### LIST OF REFERENCE SIGNS

1 Dental implant

10 Implant body

100 Abutment surface

11 Plug-in opening

110 Anti-rotation element

12 Screw opening

2 Impression device

20 Impression abutment

200 Abutment body

201 stem

202 Anti-rotation element

203 Connection opening

204 Connecting section

205 Form-fit element

206 End face

21 Impression cap

210 body

211 Collar section

212 Connecting section

213 Connecting opening

22 Connector element

220 Shaft section

221 Step

222 Shaft section

223 Screw end

224 head

A Impression compound

A1, A2 implant axis

α angle

β angle

E Removal direction

K Bone structure

L Longitudinal axis

T separation line

Z Gingiva

1. An impression device (2) for a dental implant (1), having an impression cap (21) which has a first connection opening (213) extending along a longitudinal axis (L) and a first connecting section (212), and a connector element (22) for fixing the impression cap (21) relative to the dental implant (1),
comprising
an impression abutment (20) having an abutment body (200) which, on a first side, has a front surface (206) to be attached to the dental implant (1) and, on a second side lying along the longitudinal axis (L) from the first side, a second connecting portion (204) for connecting to the first connecting portion (212) of the impression cap (2), wherein the impression abutment (20) has a second connection opening (203) extending along the longitudinal axis (L) which, in a set position, in which the impression abutment (20) and the impression cap (21) are attached to one another, is aligned along the longitudinal axis (L) with the first connection opening (213) of the impression cap (21) such that the connector element (22) can be guided through the first connection opening (212) and the second connection opening (203) for connection to the dental implant (1).

2. The impression device (2) according to claim 1, wherein the impression cap (21) can be removed from the impression abutment (20) at an angle (13) to the longitudinal axis (L) not equal to 0°.

3. The impression device (2) according to claim 1, wherein the second connecting section (204) extends under an angle (a) not equal to 0° to the longitudinal axis (L).

4. The impression device (2) according claim 1, wherein the second connecting section (204) has a conical shape.

5. The impression device (2) according to claim 1, wherein the second connecting section (204) has the shape of a truncated cone.

6. The impression device (2) according to claim 1, wherein the first connecting section (212) is shaped complementary to the second connecting section (204).

7. The impression device (2) according to claim 1, wherein the second connecting section (204) has at least one form-fitting element (202) for connecting the impression abutment to the impression cap (21) in the attached position in a rotationally fixed manner.

8. The impression device (2) according to claim 7, wherein the second connecting section (204) has a plurality of form-fit elements (202) arranged regularly with respect to one another about the longitudinal axis (L).

9. The impression device (2) according to claim 1, wherein the impression abutment (20) has a shaft (201) which protrudes from the abutment body (200) on the first side along the longitudinal axis (L) and can be inserted into a plug-in opening of the dental implant (1).

10. The impression device (2) according to claim 9, wherein the shaft (201) has at least one anti-rotation element (202) for connection to the dental implant (1) in a rotationally fixed manner.

11. The impression device (2) according to claim 1, wherein the connector element (22) has a screw end (223) to be connected to the dental implant (1) in a screwing manner.
